(19) United States
(12) Patent Application Publication
(10) Pub. No.: US 2009/0085399 A1
(43) Pub. Date: Apr. 2, 2009

(54) Sprocket, system and method for using the sprocket

(76) Inventor: John P. Moyna, Elkader, IA (US)

Correspondence Address: PATENTS+TMS, P.C., 2849 W. ARMITAGE AVE., CHICAGO, IL, 60647, US

(21) Appl. No.: 11/906,471

(22) Filed: Oct. 2, 2007

(51) Int. Cl. B62D 55/12

(52) U.S. Cl. 305/199; 305/194

(57) ABSTRACT

A sprocket, a system and a method for using the sprocket have a chain drive for moving a chain of the earth moving equipment in a clockwise direction or a counter-clockwise direction. The chain drive has a sprocket having teeth for engaging and/or for moving the chain of the earth moving equipment. Bushings attach to the teeth of the sprocket by pins and holes extending through the teeth of the sprocket. A ring attaches to a first cylinder and/or a second cylinder of the chain drive. The bushings of the sprocket exert and/or apply a force to bushings of the chain for moving the earth moving equipment on the surface. The ring of the first cylinder and/or the second cylinder contact and/or apply a force to plates which are attached to shoes of the chain. The bushings of the sprocket, the ring of the first cylinder, the ring of the second cylinder and/or the plates prevent damage to, prevents weakening of and/or prevents destruction of the chain by the chain drive.

### BACKGROUND OF THE INVENTION

The present invention generally relates to a sprocket, a system and a method for using the sprocket. More specifically, the sprocket, the system and the method for using the sprocket may engage a chain to move an earth moving equipment in a direction on a surface. The sprocket and/or the system may have bushings and/or rings which may be attachable to a sprocket. The bushings of the sprocket may engage, may contact and/or may abut the chain. The rings of the sprocket may engage, may contact and/or may abut plates of the chain. The bushings of the sprocket may apply a force to the chain. As a result, the chain may move and/or may rotate in a clockwise direction or a counter-clockwise direction by the bushings of the sprocket to move the earth moving equipment in the direction. The bushings of the sprocket, the rings and/or the plates of the track shoes may reduce deterioration of and/or may increase a longevity of the chain, the bushings of the chain and/or the sprocket.

It is generally known that earth moving equipment may be moved in a direction by a drive shaft, a chain drive and/or a chain. Typically, the chain drive of the earth moving equipment has a sprocket which is attached to the drive shaft. The chain has track links which are attached to each other by bushings. Teeth of the sprocket engage the bushings of the chain to move the earth moving equipment. The drive shaft moves the teeth of the sprocket in a clockwise direction or a counter-clockwise direction. The teeth of the sprocket engage, contact and/or abut the bushings of the chain to move the earth moving equipment. The teeth of the sprocket apply a force to the housing of the chain in a clockwise direction or a counter-clockwise direction. As a result, the earth moving equipment is moved in a direction by the chain drive, the teeth of the sprocket and/or the chain.

A track shoe is attached to each of the track links to move the earth moving equipment in the direction on a soft surface, such as, for example, dirt, sand, mud and/or the like. The sprocket of the chain drive is interposed between a first cylinder and a second cylinder. As the teeth of the sprocket move the chain, the first cylinder and/or the second cylinder contact and/or abut the shoe of each of the track links. Moreover, the first cylinder and/or the second cylinder apply a force to the track, the track links and/or the shoe of each of the track links.

However, the sprocket and the bushing of the chain are damaged, are weakened and/or are destroyed by force applied to the bushing of the chain by teeth of the sprocket as the earth moving equipment moves on the surface. Further, the chain and the shoe of each of the track links are damaged, are weakened and/or are destroyed by force applied to shoe by the first cylinder and/or the second cylinder as the earth moving equipment moves on the surface. As a result, the chain, the chain drive and/or the sprocket may be destroyed and/or may be incapable of moving the earth moving equipment in the direction on the surface.

A need, therefore, exists for a sprocket, a system and a method for using the sprocket. Additionally, a need exists for a sprocket, a system and a method for using the sprocket which may have bushings attached to teeth of a sprocket for contacting, for engaging and/or for abutting a housing of a chain. Further, a need exists for a sprocket, a system and a method for using the sprocket which may have a ring attached to a cylinder of a chain drive for contacting, for engaging and/or for abutting a shoe of a track. Still further, a need exists for a sprocket, a system and a method for using the sprocket which may attach a plate to a top surface of a track shoe for contacting, for engaging and/or for abutting a cylinder and/or the ring of the cylinder of a chain drive. Moreover, a need exists for a sprocket, a system and a method for using the sprocket which may have a bushing, a ring and/or a plate to prevent damage to, to prevent weakening of and/or to prevent destruction of a chain, a chain link, a bushing of the chain and/or a shoe of the chain link.

### SUMMARY OF THE INVENTION

The present invention generally relates to a sprocket, a system and a method for using the sprocket. More specifically, the present invention relates to a sprocket, a system and a method for using the sprocket which may attach bushings to teeth of a sprocket for contacting, for engaging, for abutting and/or for moving a track connected to the sprocket. The bushing of the sprocket may apply a force in a clockwise direction or a counter-clockwise direction to the bushings of the chain. As a result, the track may move and/or may rotate in a clockwise direction or a counter-clockwise direction to move a earth moving equipment.

The sprocket may have a first cylinder connected and/or a second cylinder attached to the sprocket for moving the earth moving equipment. A ring may be attached to the first cylinder and/or the second cylinder. The ring of the first cylinder and/or the second cylinder may contact and/or may abut a top surface of the shoe of the track to move the earth moving equipment. A top side of the shoe may have a plate attached for engaging the first cylinder and/or the second cylinder. The ring of the first cylinder and/or the second cylinder may contact and/or may abut the plate of the track shoe to move the earth moving equipment.

To this end, in an embodiment of the present invention, a system for moving earth moving equipment on a surface wherein the earth moving equipment has a drive shaft and a chain for moving the vehicle in a direction on the surface is provided. The system has a sprocket attached to the drive shaft wherein the sprocket has a plurality of teeth exerting a force against the chain wherein the force moves the chain. Further, the system has a plurality of shoes attached to the chain wherein each of the plurality of shoes has a top side and a bottom side opposite to the top side wherein the bottom side of each of the plurality of shoes contacts the surface. Still further, the system has a cylinder attached to the sprocket wherein the cylinder contacts at least one of the plurality of shoes wherein the drive shaft moves the sprocket and cylinder. Moreover, the system has a first bushing attached to each of the plurality of teeth of the sprocket wherein the first bushing exerts the force from the drive shaft on the chain and further wherein the sprocket and the first bushing move the earth moving equipment.

In an embodiment, the system has a pin attaching the first bushing to each of the plurality of teeth of the sprocket.

In an embodiment, the system has a hole extending through each of the plurality of teeth of the sprocket to connecting the first bushing.

In an embodiment, the system has a ring located between the cylinder and the chain.

In an embodiment, the system has a plate attached to the top side of each of the plurality of shoes.

In an embodiment, the chain has a second bushing.

In an embodiment, the first bushing is made from steel or plastic.

In another embodiment of the present invention, a system for moving earth moving equipment in a direction on a surface wherein the earth moving equipment has a drive shaft and a chain with a plurality of track links connected by a plurality of first bushings wherein a plurality of shoes are attached to the chain wherein each of the plurality of shoes has a top side and a bottom side opposite to the top side wherein the bottom side of the plurality of shoes contacts the surface is provided. The system has a chain drive connected to the drive shaft wherein the chain drive applies a force from the drive shaft to the plurality of first bushings of the chain wherein the chain drive has a cylinder contacting one of the plurality of shoes. Further, the system has a plate connected to the top side of each of the plurality of shoes. Moreover, the system has a ring attached to the cylinder wherein the ring contacts the plate wherein the chain drive moves the earth moving equipment in the direction on the surface.

In an embodiment, the system has a second bushing attached to the chain drive for contacts the plurality of first bushings of the chain.

In an embodiment, the system has a sprocket connecting the chain drive and the chain.

In an embodiment, the system has a weld attaching the plate to each of the plurality of shoes.

In an embodiment, the plate is made from steel.

In an embodiment, the ring is made from rubber.

In an embodiment, the system has a bar attaching the plate to each of the plurality of shoes.

In another embodiment of the present invention, a method for moving earth moving equipment in a direction on a surface wherein the earth moving equipment has a drive shaft and a chain having track links connected by first bushings wherein a shoe is attached to each of the track links wherein the shoe has a top side and a bottom side opposite to the top side wherein the bottom side of the shoe contacts the surface is provided. The method has the steps of attaching a sprocket to the drive shaft wherein the sprocket has teeth for engaging the chain wherein the sprocket moves the earth moving equipment in the direction on the surface. Further, the method has the steps of connecting second bushings to the teeth of the sprocket and applying a force to the first bushings of the chain with the second bushings of the sprocket wherein the second bushings are located between the sprocket and the chain wherein the force moves the earth moving equipment in the direction on the surface.

In an embodiment, the method has the step of attaching a plate to the top side of the shoe.

In an embodiment, the method has the step of inserting a pin into the teeth of the sprocket.

In an embodiment, the method has the step of connecting a ring to the sprocket for contacting the top side of the shoe.

In an embodiment, the method has the step of removing the second bushings from the sprocket.

In an embodiment, the method has the step of moving the chain with the second bushings of the sprocket.

It is, therefore, an advantage of the present invention to provide a sprocket, a system and a method for using the sprocket which may prevent damage to a chain, a bushing of the chain, a chain link of the chain and/or a shoe of the chain.

Another advantage of the present invention is to provide a sprocket, a system and a method for using the sprocket which may have a bushing attachable to a sprocket for contacting and/or for abutting a bushing of a chain.

Yet another advantage of the present invention is to provide a sprocket, a system and a method for using the sprocket which may move a chain in a clockwise direction or a counter-clockwise direction with a bushing attached to a tooth of a sprocket.

Still another advantage of the present invention is to provide a sprocket, a system and a method for using the sprocket which may have a bushing attachable to a tooth of a sprocket for preventing damage to a bushing of a chain.

A further advantage of the present invention is to provide a sprocket, a system and a method for using the sprocket which may have a pin for attaching a bushing to a tooth of a sprocket.

Yet another advantage of the present invention is to provide a sprocket, a system and a method for using the sprocket which may have a first ring and/or a second ring attachable to a chain drive for contacting a top side of a shoe of a track.

A still further advantage of the present invention is to provide a sprocket, a system and a method for using the sprocket which may provide a first ring and/or a second ring attachable to a chain drive to prevent damage to a shoe of and/or a track link of a chain.

Moreover, an advantage of the present invention is to provide a sprocket, a system and a method for using the sprocket which may have a plate attachable to a top side of a shoe of a track to prevent damage to the chain.

And, another advantage of the present invention is to provide a sprocket, a system and a method for using the sprocket which may provide a bushing of a sprocket, a first ring of a chain drive, a second ring of a chain drive and/or a plate of a shoe of a chain to prevent damage to the chain of the earth moving equipment.

Yet another advantage of the present invention is to provide a sprocket, a system and a method for using the sprocket which may have a bushing of a sprocket made from, for example, plastic or steel.

Another advantage of the present invention is to provide a sprocket, a system and a method for using the sprocket with a ring of a chain drive made from, for example, rubber.

Yet another advantage of the present invention is to provide a sprocket, a system and a method for using the sprocket which may have a plate of a shoe made from steel.

A still further advantage of the present invention is to provide a sprocket, a system and a method for using the sprocket which may prevent damage from a force applied by a tooth of a sprocket to a bushing of a chain and/or a shoe of a chain.

Moreover, an advantage of the present invention is to provide a sprocket, a system and a method for using the sprocket which may prevent damage from a force applied by a first cylinder of a chain drive and/or a second cylinder of the chain drive to a chain link of a chain.

Additional features and advantages of the present invention are described in, and will be apparent from, the detailed description of the presently preferred embodiments and from the drawings.

### BRIEF DESCRIPTION OF THE DRAWINGS

FIG. 1 illustrates a plan view of one type of earth moving equipment having a chain drive and a chain in an embodiment of the present invention.

FIG. 2 illustrates a perspective view of a chain drive in an embodiment of the present invention.

FIG. 3 illustrates a cross-sectional view of a chain drive and a chain in an embodiment of the present invention.

FIG. 4 illustrates an enlarged cross-sectional view of the chain drive and the chain of FIG. 2.

FIG. 5 illustrates a side view of a track shoe and a plate in an embodiment of the present invention.

### DETAILED DESCRIPTION OF THE PRESENTLY PREFERRED EMBODIMENTS

The present invention generally relates to a sprocket, a system and a method for using the sprocket. The sprocket and/or the system may have a chain drive for moving and/or for rotating a chain of the earth moving equipment in, for example, a clockwise direction or a counter-clockwise direction. As a result, the vehicle may be moved in, for example, a forward direction or a backward direction with respect to the vehicle. The chain drive may have a sprocket located between a first cylinder and/or a second cylinder. Bushings may attach to teeth of the sprocket, and a ring may cover the first cylinder and/or the second cylinder. Plates may attach to a top side of the track shoes and or may contact the ring of the first cylinder and/or the ring of the second cylinder.

The bushings of the sprocket may exert and/or may apply a force in the clockwise direction and/or the counter-clockwise direction to the bushings of chain to move the earth moving equipment. The ring of the first cylinder and/or the second cylinder may contact the plates of the track shoes to move the earth moving equipment. As a result, the sprocket may drive, may move and/or may rotate the chain in the clockwise direction or the counter-clockwise direction. The bushings of the sprocket, the ring of the first cylinder, the ring of the second cylinder and/or the plates of the track shoes may prevent damage to, may prevent weakening of and/or may prevent destruction of the chain links, the track shoes and/or the chain.

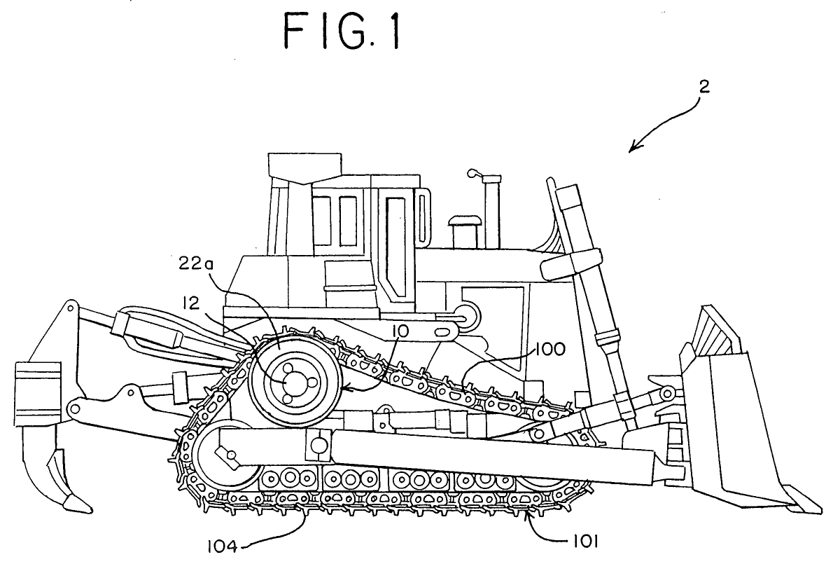

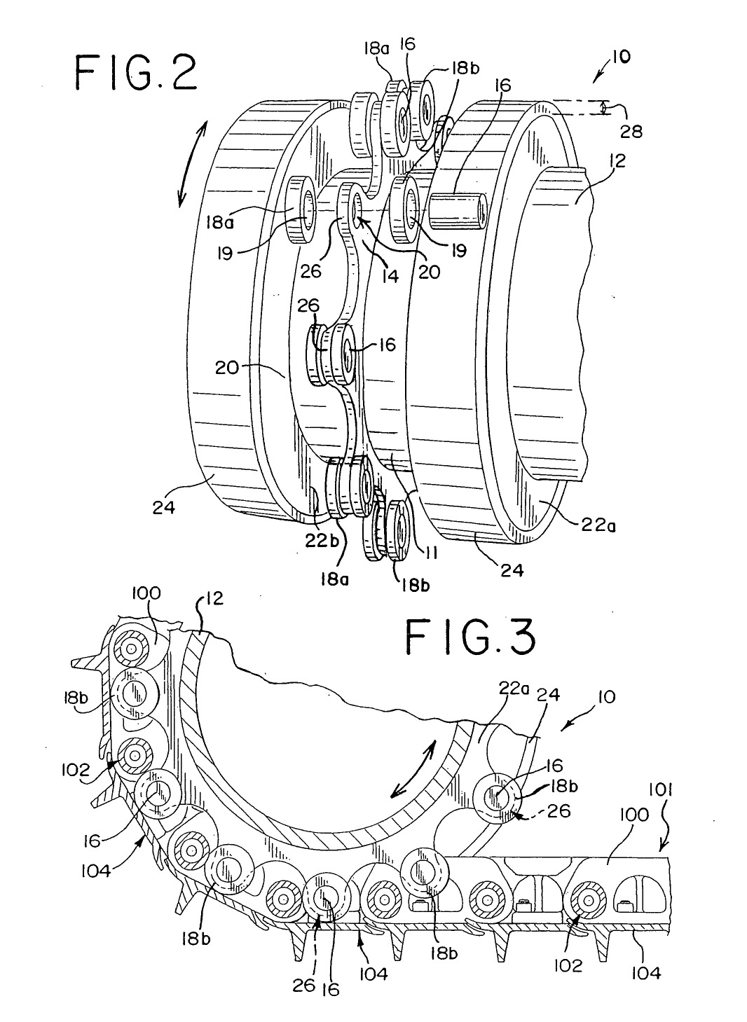

Referring now to the drawings wherein like numerals refer to like parts, FIGS. 1 and 2 illustrate one type of earth moving equipment 2 having a chain drive 10 in an embodiment of the present invention. The chain drive 10 may move the earth moving equipment 2. The chain drive 10 and the chain 101 (as shown in FIGS. 2 and 3) may move the earth moving equipment 2 in a direction on a surface. The earth moving equipment 2 may be a land vehicle, such as, for example, a bulldozer, a crawler tractor, a tank, a truck, an off-road vehicle, an all-terrain vehicle, a military vehicle, a construction vehicle, an engineering vehicle and/or the like. The present invention should not be limited to a specific embodiment of the land vehicle of the earth moving equipment 2 illustrated in FIG. 1.

The chain drive 10 of the earth moving equipment 2 may have a drive shaft 12 for moving the earth moving equipment 2. The drive shaft 12 may have a first cylinder 22a, a second cylinder 22b and/or a sprocket 11. The sprocket 11 may be located between the first cylinder 22a and the second cylinder 22b. The earth moving equipment 2 may have a motor (not shown in the figures) to move the earth moving equipment 2. The motor may rotate, may spin and/or may move the drive shaft 12 in a direction, such as, for example, a clockwise direction or a counter-clockwise direction as indicated by the arrows in FIG. 2. The sprocket 11, the first cylinder 22a and/or the second cylinder 22b may move, may spin and/or may rotate in the direction of the drive shaft 12 as indicated by the arrows in FIG. 2. The sprocket 11, the first cylinder 22a and/or the second cylinder 22b may not be movable with respect to each other.

The sprocket 11 may have teeth 26, first bushings 18a, second bushings 18b and/or pins 16. The teeth 26 of the sprocket 11 may extend radially outward with respect to the sprocket 11. The teeth 26 of the sprocket 11 may have a hole 20 extending through each of the teeth 26 for receiving the pins 16. The teeth 26 may be equally spaced and may be continuous around the circumference of the sprocket 11. The first bushings 18a and/or the second bushings 18b may be made from a material, such as, for example, steel or plastic. The material of the first bushings 18a and/or the second bushings 18b may have a softness which may be greater than a softness of a material of the sprocket 11. The present invention should not be limited to a specific embodiment of a specific material of the first bushings 18a and/or the second bushings 18b.

One of the pins 16 may be insertable into the hole 20 of each one of the teeth 26 for attaching one of the first bushings 18a and/or one of the second bushings 18b to the sprocket 11. Each of the pins 16 may extend outward with respect to the sprocket 11 for receiving each of the first bushings 18a and/or each of the second bushings 18b. Each of the first bushings 18a and/or each of the second bushings 18b may have a hole 19 for receiving one of the pins 16. The hole 19 of each of the first bushings 18a and/or each of the second bushings 18b may receive one of the pins 16. As a result, one of the first bushings 18a and/or one of the second bushings 18b may be attached to one of the teeth 26 of the sprocket 11 via one of the pins 16 and the hole in the sprocket 11. Further, the each of the first bushings 18a may be adjacent to the second cylinder 22b. Still further, each of the second bushings 18b may be adjacent to the first cylinder 22a. Moreover, the first bushings 18a and/or the second bushings 18b may abut and/or may contact the sprocket 11.

The first cylinder 22a and/or the second cylinder 22b may have a ring 24. The ring 24 may be attached to the first cylinder 22a and/or the second cylinder 22b. The ring 24 may surround a circumference of the first cylinder 22a and/or a circumference of the second cylinder 22b. The ring 24 may have a thickness 28 which may be, for example, one inch. The ring 24 may be made from a material, such as, for example, rubber and/or plastic. The material of the ring 24 may have a softness which may be greater than a softness of a material of the first cylinder 22a and/or the second cylinder 22b. The present invention should not be limited to a specific embodiment of the thickness 28 and/or a specific material of the ring 24. It should be understood that the thickness 28 of the ring 24 may be any thickness known to one having ordinary skill in the art.

FIGS. 2 and 3 illustrate the chain drive 10 which may be attached to and/or may be connected to a chain 101 for moving the earth moving equipment 2. The chain 101 may include links 100 which may be connected to each other and/or may be attached to each other by a bushing 102. The bushing 102 may have and/or may house oil cartridges (not shown in the drawings). Shoes 104 may be attached to and/or may be connected to each of the links 100 for contacting the surface. The shoes 104 may extend outward with respect to the links 100.

The sprocket 11 may rotate and/or may move in the clockwise direction or the counter-clockwise direction by a rotation of the drive shaft 12 which may be caused by operating the motor. For example, a user (not shown in the figures) may activate the motor to move the earth moving equipment 2 in a forward direction with respect to the earth moving equipment 2. The motor may apply a torque force in a clockwise direction to the drive shaft 12. The torque force from the motor may move and/or may rotate the drive shaft 12 in the clockwise direction. As a result, the sprocket 11, the first cylinder 22a and/or the second cylinder 22b may rotate and/or may move in a clockwise direction.

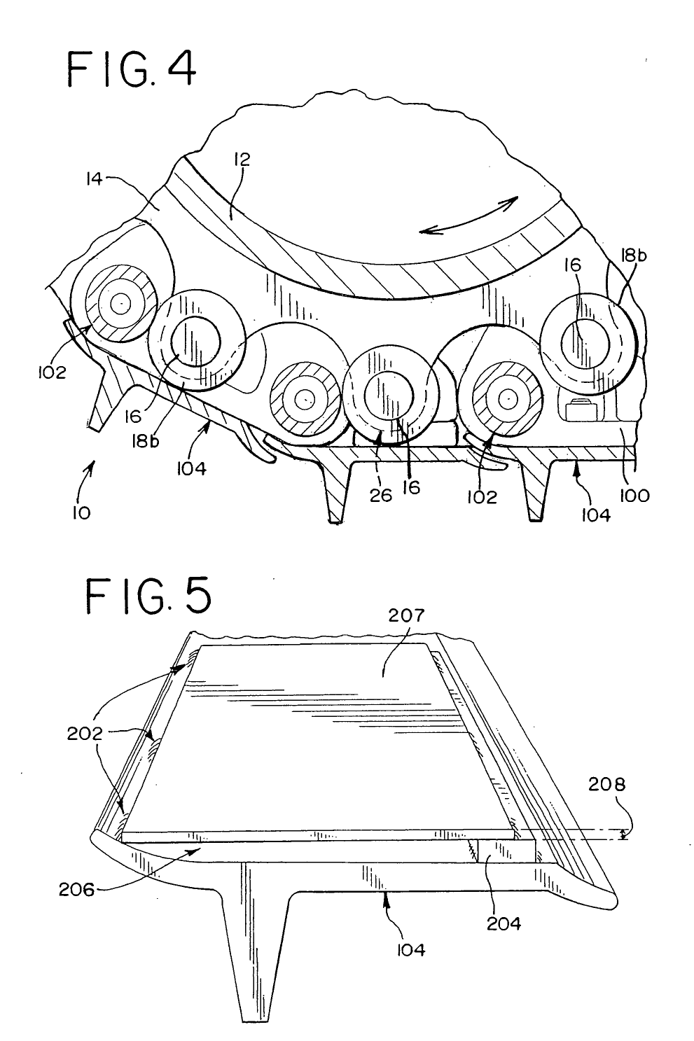

The bushings 18a, 18b of each of the teeth 26 of the sprocket 11 may contact, may engage and/or may abut the bushing 102 of the chain 101 as illustrated in FIGS. 3 and 4. The bushings 18a, 18b of each of the teeth 26 of the sprocket 11 may exert and/or may apply a force in the clockwise direction based on the torque force of the motor. Each of the bushings 18a, 18b may apply and/or may exert the force against each of the bushings 102 of the chain 101. The force from the bushings 18a, 18b may move, may pull and/or may rotate the chain 101 in the clockwise direction. The chain drive 10 may move the chain 101 and the shoes 104 in the clockwise direction. As a result, the earth moving equipment 2 may be moved in the forward direction with respect to the earth moving equipment 2 via the chain drive 10, the chain 101 and the shoes 104.

The softness of the bushings 18a, 18b of the sprocket 11 may protect each of the teeth 26 of the sprocket 11 from being damaged by the bushing 102 of the chain 101 during operation of the earth moving equipment 2. Additionally, the softness of the bushings 18a, 18b may protect the bushing 102 of the chain 101 from being damaged by the teeth 26 of the sprocket 11 during the operation of the earth moving equipment 2. As a result, the bushings 18a, 18b may prevent the sprocket 11 and/or the bushing 102 of the chain 101 from being damaged, from being weakened and/or from being destroyed by the force applied by the motor, the drive shaft 12 and/or each of the teeth 26 of the sprocket 11. The first bushings 18a and/or the second bushings 18b may be removed from the sprocket 11 to be replaced, to be examined and/or to be cleaned.

As shown in FIG. 3, the ring 24 of the first cylinder 22a and/or the second cylinder 22b may contact and/or may abut a top surface 206 of the shoe 104 of the chain 101. The ring 24 of the first cylinder 22a and/or the second cylinder 22b may apply and/or may exert the torque force from the motor against the top side 206 of the shoes 104 of the track links 100. For example, the ring 24 of the first cylinder 22a may apply the torque force in a clockwise direction against the track shoes 104 of the track links 100. As a result, the ring 24 of the first cylinder 22a and/or the second cylinder 22b may aid and/or may assist the sprocket 11 in moving the chain in the clockwise direction. The ring 24 may be removed from the first cylinder 22a and/or the second cylinder 22b to be replaced, to be examined and/or to be cleaned.

The softness of the ring 24 may protect the first cylinder 22a and/or the second cylinder 22b from being damaged by the shoe 104 of the chain 101. Additionally, the softness of the ring 24 may protect the shoe 104 from being damaged by the first cylinder 22a and/or the second cylinder 22b. As a result, the ring 24 may prevent the first cylinder 22a, the second cylinder 22b and/or the chain 101 from being damaged by, from being weakened by and/or from being destroyed by the force applied by the first cylinder 22a and/or the second cylinder 22b.

The shoe 104 of the chain 101 may move, may twist, may turn and/or may shift with respect to the chain links 100 of the chain 101. As a result, the shoe 104 may apply and/or may exert a force against the chain links 100, the first cylinder 22a and/or the second cylinder 22b. The force of the shoe 104 against the chain links 100 may damage, may weaken and/or may destroy the chain links 100, the first cylinder 22a and/or the second cylinder 22b. The softness of the ring 24 of the first cylinder 22a and/or the second cylinder 22b may protect the first cylinder 22a, the second cylinder 22b and/or the chain links 100 from the force applied by the shoe 104 of the chain 101. As a result, the ring 24 of the first cylinder 22a and/or the second cylinder 22b may prevent the force of the shoe 104 from damaging, from weakening and/or from destroying the chain links 100, the first cylinder 22a and/or the second cylinder 22b.

FIG. 4 illustrates the shoe 104 of the chain 101 which may have a plate 207. Each shoe 104 of the chain 101 may have the plate 207. The plate 207 may have a thickness 208 which may be, for example, one-quarter of an inch. The plate 207 may be made from a material, such as, for example, steel or rubber. The material of the plate 207 may have a softness which may be greater than a softness of a material of the shoe 104. The softness of the plate 207 may protect the shoe 104, the first cylinder 22a and/or the second cylinder 22b from the force applied to the shoe 104 by the first cylinder 22a and/or the second cylinder 22b. As a result, the plate 207 may prevent the first cylinder 22a, the second cylinder 22b and/or the shoe 104 from being damaged, from being weakened and/or from being destroyed by the force applied to the shoe by the first cylinder 22a and/or the second cylinder 22b. The present invention should not be limited to a specific embodiment of the thickness 208 and/or a specific material of the plate 207. It should be understood that the thickness 208 of the plate 207 may be any thickness known to one having ordinary skill in the art.

A bar 204 may be attached to the top side 206 of the shoe 104. The plate 207 may be attached to the bar 204 by, for example, a weld. A fastener 202 may connect and/or may attach the plate 207 to the top side 206 of the shoe 104. The fastener 202 may be, for example, a weld, a pin, a hook and/or the like. As a result, the plate 207 may be connected to and/or may be attached to the top side 206 of the shoe 104. The present invention should not be limited to a specific embodiment of the fastener 202. The plate 207 may be removed from the shoe 104 to be replaced, to be examined and/or to be cleaned. It should be understood that the plate 207 may be attached to the top side 206 of the shoe 104 by any means known to one having ordinary skill in the art.

The motor, the chain drive 10 and the chain 101 of the earth moving equipment 2 may move the earth moving equipment 2 on the surface. The chain drive 10 may have the bushings 18a, 18b and/or the ring 24 to protect the sprocket 11 and the chain 101 from damage from the force applied to the chain 101 by the sprocket 11. Each shoe 104 may have the plate 207 to protect the shoe 104, the first cylinder 22a and/or the second cylinder 22b from force applied to the top of the shoe 206 by the first cylinder 22a and/or the second cylinder 22b.

It should be understood that various changes and modifications to the presently preferred embodiments described herein will be apparent to those skilled in the art. Such changes and modifications may be made without departing from the spirit and scope of the present invention and without diminishing its attendant advantages.

I claim:

1. A system for moving earth moving equipment on a surface wherein the earth moving equipment has a drive shaft and a chain for moving the vehicle in a direction on the surface, the system comprising:
a sprocket attached to the drive shaft wherein the sprocket has a plurality of teeth exerting a force against the chain wherein the force moves the chain;
a plurality of shoes attached to the chain wherein each of the plurality of shoes has a top side and a bottom side opposite to the top side wherein the bottom side of each of the plurality of shoes contacts the surface;
a cylinder attached to the sprocket wherein the cylinder contacts at least one of the plurality of shoes wherein the drive shaft moves the sprocket and cylinder; and
a first bushing attached to each of the plurality of teeth of the sprocket wherein the first bushing exerts the force from the drive shaft on the chain and further wherein the sprocket and the first bushing move the earth moving equipment.

2. The system of claim 1 further comprising:
a pin attaching the first bushing to each of the plurality of teeth of the sprocket.

3. The system of claim 1 further comprising:
a hole extending through each of the plurality of teeth of the sprocket to connecting the first bushing.

4. The system of claim 1 further comprising:
a ring located between the cylinder and the chain.

5. The system of claim 1 further comprising:
a plate attached to the top side of each of the plurality of shoes.

6. The system of claim 1 wherein the chain has a second bushing.

7. The system of claim 1 wherein the first bushing is made from steel or plastic.

8. A system for moving earth moving equipment in a direction on a surface wherein the earth moving equipment has a drive shaft and a chain with a plurality of track links connected by a plurality of first bushings wherein a plurality of shoes are attached to the chain wherein each of the plurality of shoes has a top side and a bottom side opposite to the top side wherein the bottom side of the plurality of shoes contacts the surface, the system comprising:
a chain drive connected to the drive shaft wherein the chain drive applies a force from the drive shaft to the plurality of first bushings of the chain wherein the chain drive has a cylinder contacting one of the plurality of shoes;
a plate connected to the top side of each of the plurality of shoes; and
a ring attached to the cylinder wherein the ring contacts the plate wherein the chain drive moves the earth moving equipment in the direction on the surface.

9. The system of claim 8 further comprising:
a second bushing attached to the chain drive for contacts the plurality of first bushings of the chain.

10. The system of claim 8 further comprising:
a sprocket connecting the chain drive and the chain.

11. The system of claim 8 further comprising:
a weld attaching the plate to each of the plurality of shoes.

12. The system of claim 8 wherein the plate is made from steel.

13. The system of claim 8 wherein the ring is made from rubber.

14. The system of claim 8 further comprising:
a bar attaching the plate to each of the plurality of shoes.

15. A method for moving earth moving equipment in a direction on a surface wherein the earth moving equipment has a drive shaft and a chain having track links connected by first bushings wherein a shoe is attached to each of the track links wherein the shoe has a top side and a bottom side opposite to the top side wherein the bottom side of the shoe contacts the surface, the method comprising the steps of:
attaching a sprocket to the drive shaft wherein the sprocket has teeth for engaging the chain wherein the sprocket moves the earth moving equipment in the direction on the surface;
connecting second bushings to the teeth of the sprocket;
applying a force to the first bushings of the chain with the second bushings of the sprocket wherein the second bushings are located between the sprocket and the chain wherein the force moves the earth moving equipment in the direction on the surface.

16. The method of claim 15 further comprising the step of:
attaching a plate to the top side of the shoe.

17. The method of claim 15 further comprising the step of:
inserting a pin into the teeth of the sprocket.

18. The method of claim 15 further comprising the step of:
connecting a ring to the sprocket for contacting the top side of the shoe.

19. The method of claim 15 further comprising the step of:
removing the second bushings from the sprocket.

20. The method of claim 15 further comprising the step of:
moving the chain with the second bushings of the sprocket.
